(19) United States
(12) Patent Application Publication
(10) Pub. No.: US 2020/0217266 A1
(43) Pub. Date: Jul. 9, 2020

(54) DIESEL FUEL QUANTITY ADJUSTMENT FAST LEARN

(71) Applicant: GM Global Technology Operations LLC, Detroit, MI (US)

(72) Inventors: Eric M. Sisco, Bruce Twp, MI (US); Douglas A. Kopp, Fenton, MI (US); Neil Anderson, Howell, MI (US)

(21) Appl. No.: 16/242,675

(22) Filed: Jan. 8, 2019

(51) Int. Cl. F02D 41/40; F02M 65/00; F02D 41/38

(52) U.S. Cl. CPC F02D 41/401; F02M 65/001; F02D 2200/0618; F02D 2200/0614; F02D 41/3836

(57) ABSTRACT

A method of operating a fuel injector includes determining an actual energizing time correction value for a fuel injector at a first fuel rail pressure, calculating an extrapolated energizing time correction value by performing a mathematical calculation on the actual energizing time correction value, and controlling the operation of the fuel injector based on the actual energizing time correction value and the extrapolated energizing time correction value.

### INTRODUCTION

The present disclosure relates to systems and methods for learning and applying adjustment values for diesel fuel injectors.

Internal combustion engines may be equipped with fuel injectors used to provide fuel to the cylinders of the engine, under control of an electronic control unit (ECU). In practice, the ECU determines the fuel quantity to be injected by the fuel injector and energizes the injector for an energizing time to deliver the desired quantity. The relationship between energizing time and injected fuel quantity may vary from injector to injector due to manufacturing tolerances and aging effects in service. Learning methods can be used to determine adjustments to be made in the energizing time for a specific injector to precisely deliver the desired fuel quantity. The time that is required to learn the required adjustment values for all of the injectors in an engine over a range of fuel pressures may be considerable.

Thus, while current learning methods achieve their intended purpose, there is a need for a new and improved system and method for learning the required adjustment values of fuel injectors in an engine.

### SUMMARY

According to several aspects, a method of operating a fuel injector of an internal combustion engine includes determining an actual energizing time correction value for a fuel injector at a first fuel rail pressure, calculating a first extrapolated energizing time correction value by performing a first mathematical calculation on the actual energizing time correction value, and controlling the operation of the fuel injector based on the actual energizing time correction value and the first extrapolated energizing time correction value.

In a further aspect of the present disclosure, the step of determining an actual energizing correction value includes setting a first fuel rail pressure of a fuel rail that is configured to provide fuel to the fuel injector, performing a test injection by energizing the fuel injector for a first energizing time at the first fuel rail pressure, and determining an actual quantity of fuel injected by the fuel injector during the test injection. The step of determining an actual energizing correction value further includes determining the difference between the first energizing time and a nominal energizing time corresponding to the actual quantity of fuel injected during the test injection.

In an additional aspect of the method of the present disclosure, the engine is a multi-cylinder engine including one fuel injector for each cylinder, and the step of determining an actual energizing correction value is performed once for each of the plurality of fuel injectors in the engine.

In another aspect of the method of the present disclosure, the method further includes calculating a second extrapolated energizing time correction value by performing a second mathematical calculation on the actual energizing time correction value.

In yet another aspect of the method of the present disclosure, the learning cycle further includes calculating a third extrapolated energizing time correction value by performing a third mathematical calculation on the actual energizing time correction value.

In a further aspect of the method of the present disclosure, the first mathematical calculation comprises multiplying the actual energizing time correction value by a predetermined constant.

In another aspect of the method of the present disclosure, the first mathematical calculation comprises adding the actual energizing time correction value to a predetermined constant.

In another aspect of the method of the present disclosure, the first mathematical calculation comprises multiplying the actual energizing time correction value by a first predetermined constant and adding the product of the multiplication to a second predetermined constant.

In another aspect of the method of the present disclosure, the step of determining an actual energizing correction value is performed during a DFCO event.

In a further aspect of the present disclosure, an automotive system includes an electronic control unit configured to carry out the method of operating a fuel injector as described above.

In another aspect of the present disclosure, a non-transitory computer-readable medium contains instructions that, when executed on a computer, performs the method of operating a fuel injector as described above.

According to several aspects, an apparatus for operating a fuel injector of an internal combustion engine apparatus includes an electronic control unit configured to determine an actual energizing time correction value for a fuel injector at a first fuel rail pressure, calculate a first extrapolated energizing time correction value by performing a first mathematical calculation on the actual energizing time correction value; and control the operation of the fuel injector based on the actual energizing time correction value and the first extrapolated energizing time correction value.

In another aspect of the present disclosure, the apparatus further includes a non-transitory computer-readable medium associated with the electronic control unit and including a computer program having programming instructions.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an automotive system according to an exemplary embodiment;

FIG. 2 is a cross section of an internal combustion engine that is a part of the automotive system of FIG. 1 according to an exemplary embodiment;

FIG. 3 is a flowchart of a method of learning injector energizing time adjustment values according to an exemplary embodiment;

FIG. 4 is a chart providing examples of learned injector energizing time adjustment values according to an exemplary embodiment.

### DETAILED DESCRIPTION

The following description is merely exemplary in nature and is not intended to limit the present disclosure, or the application or uses of the present disclosure.

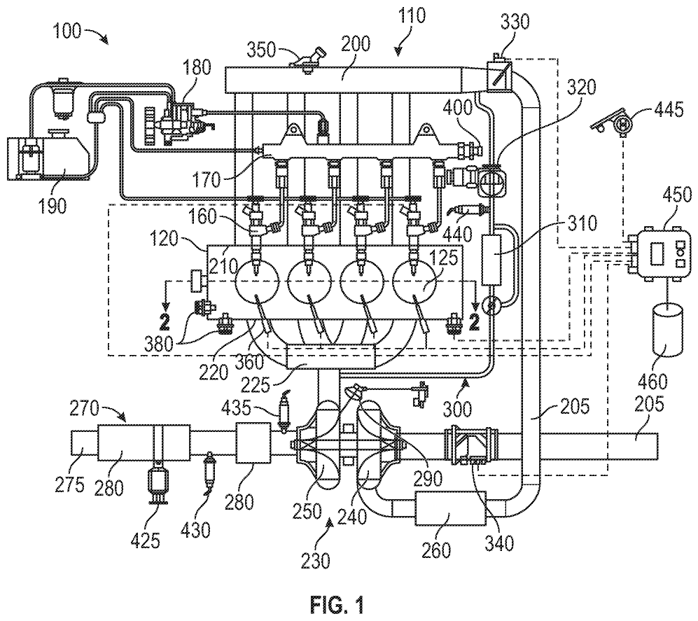

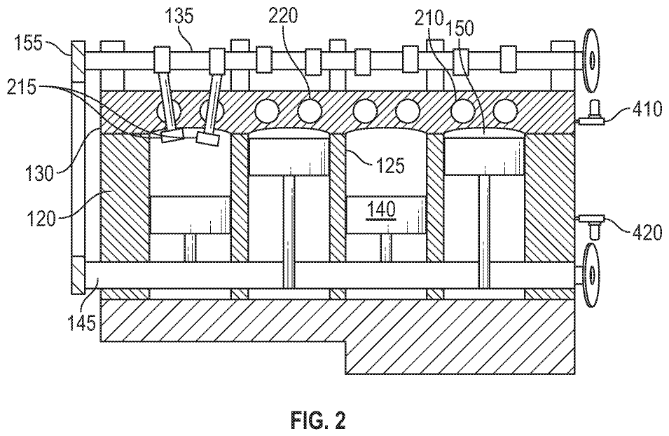

Some embodiments may include an automotive system 100, as shown in FIGS. 1 and 2, that includes an internal combustion engine (ICE) 110 having a cylinder block 120 defining at least one cylinder 125 having a piston 140 coupled to rotate a crankshaft 145. The non-limiting example engine depicted in FIGS. 1 and 2 shows four cylinders, but it will be appreciated that an engine having more than four cylinders or fewer than four cylinders is within the scope of the present disclosure. A cylinder head 130 cooperates with the piston 140 to define a combustion chamber 150.

A fuel and air mixture is injected in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high-pressure fuel pump 180 that increase the pressure of the fuel received from a fuel source 190.

Each of the cylinders 125 has at least two valves 215, actuated by a camshaft 135 rotating in time with the crankshaft 145. The valves 215 selectively allow air into the combustion chamber 150 from the intake port 210 and alternately allow exhaust gases to exit through an exhaust port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle valve 330 may be provided to regulate the flow of air into the intake manifold 200. In still other embodiments, a forced air system such as a turbocharger 230, having a compressor 240 rotationally coupled to a turbine 250, may be provided. Rotation of the compressor 240 increases the pressure and temperature of the air in the air intake duct 205 and intake manifold 200. An intercooler 260 disposed in the air intake duct 205 may reduce the temperature of the air.

The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust gas aftertreatment system 270. This example shows a variable geometry turbine (VGT) 250 with a VGT actuator 290 arranged to move the vanes to alter the flow of the exhaust gases through the turbine 250.

The exhaust gas aftertreatment system 270 may include an exhaust pipe 275 having one or more exhaust aftertreatment devices 280. The aftertreatment devices 280 may be any device configured to change the composition of the exhaust gases. Some examples of aftertreatment devices 280 include, but are not limited to, catalytic converters (two and three way), oxidation catalysts, lean NOx traps, hydrocarbon absorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow, pressure, temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, an exhaust temperature sensor 425, an EGR temperature sensor 440, and an accelerator pedal position sensor 445. The sensors may also include an exhaust gas pressure sensor 430, which is located in the exhaust pipe 275 for measuring a pressure therein, and an oxygen sensor 435, for example a Universal Exhaust Gas Oxygen (UEGO) sensor or a lambda sensor or a nitrogen oxides sensor, for measuring an oxygen concentration in the exhaust gas present in the exhaust gas aftertreatment system 270.

Furthermore, the ECU 450 may generate output signals to various control devices that are arranged to control the operation of the ICE 110, including, but not limited to, the fuel injector 160, the throttle valve 330, the EGR Valve 320, the VGT actuator 255, and the cam phaser 155. Note, dashed lines are used to indicate communication between the ECU 450 and the various sensors and devices, but some are omitted for clarity.

Turning now to the ECU 450, this apparatus may include a digital central processing unit (CPU 460) in communication with a memory system and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

The program stored in the memory system is transmitted from outside via a cable or in a wireless fashion. Outside the automotive system 100 it is normally visible as a computer program product, which is also called computer-readable medium or machine readable medium in the art, and which should be understood to be a computer program code residing on a carrier, the carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulated technique such as QPSK for digital data, such that binary data representing the computer program code is impressed on the transitory electromagnetic signal. Such signals are e.g. made use of when transmitting computer program code in a wireless fashion via a Wi-Fi connection to a laptop.

In case of a non-transitory computer program product the computer program code is embodied in a tangible, computer-readable storage medium. The storage medium is then the non-transitory carrier mentioned above, such that the computer program code is permanently or non-permanently stored in a retrievable way in or on this storage medium. The storage medium can be of conventional type known in computer technology such as a flash memory, an ASIC, a CD or the like.

Instead of an ECU 450, the automotive system 100 may have a different type of processor to provide the electronic logic, e.g. an embedded controller, an onboard computer, or any processing module that might be deployed in the vehicle.

The combustion process in an internal combustion engine results in the generation of undesirable gaseous byproducts, including hydrocarbons and oxides of nitrogen. Allowable emission levels of undesirable combustion byproducts at the tailpipe of a motor vehicle are limited by various government regulations. Aftertreatment devices are commonly employed between the engine exhaust manifold and the tailpipe to chemically alter the constituents of the combustion byproducts to meet the government regulations. The aftertreatment devices used to treat exhaust from a diesel engine may include oxidizing catalytic converters, selective catalytic reduction (SCR) converters, and diesel particulate traps.

One of the tasks of the ECU 450 may be that of controlling and correcting the amount of fuel the fuel injector 160 injects. Engine-out emissions can be reduced by precise control of engine operation, including control of the amount of fuel injected. A nominal characteristic curve relating the amount of fuel injected to the energizing time of the fuel injector 160 can be established by measuring the characteristics of a population of fuel injectors. In practice, individual fuel injectors 160 have associated tolerances that may be caused by manufacturing variation and/or wear in service, resulting in the actual fuel delivered by a given injector 160 deviating from the fuel delivery that would be predicted by the nominal characteristic curve. To minimize the effect of fuel injector variation, algorithms may be used to learn the characteristics of each individual injector 160 in an engine and to apply a correction factor based on the learned characteristics, the correction factor being used to modify the commanded energizing time for the individual injector 160. The amount of fuel delivered by a fuel injector 160 also depends on the pressure of fuel provided to a fuel input port of the injector by the fuel rail 170. Therefore, the learned correction factor must be further adjusted to account for fuel pressure in the fuel rail 170.

An algorithm for learning the characteristics of the fuel injectors in an engine may involve actuating a fuel injector 160 for a known energizing time to inject a quantity of fuel at a predetermined fuel rail pressure into a cylinder 125 of the engine during a time interval, such as deceleration fuel cutoff (DFCO), when fuel would not normally be injected. Since it is not possible to directly measure the quantity of fuel injected into a running engine during normal use of the vehicle, indirect methods are used to estimate the actual injected quantity by correlating the actual injected quantity with a measureable signal. Examples of measurable signals include but are not limited to crankshaft acceleration, O₂ concentration, and in-cylinder pressure. The discussion that follows assumes that crankshaft acceleration is used to estimate the actual injected quantity, although it will be appreciated that a different measurable signal can be used without departing from the scope of the present disclosure.

By measuring a signal such as angular acceleration of the engine crankshaft 145 resulting from the injected quantity of fuel, the torque produced by the amount of injected fuel can be determined. By comparing the produced torque to an expected torque value for the given energizing time and fuel pressure, a correction value can be learned for the specific fuel injector 160 at the specific fuel pressure. A map of correction values for all of the fuel injectors over a range of fuel pressures can be built by repeating this process for each of the injectors at each of the fuel pressures of interest.

Governmental requirements for onboard diagnostic systems (OBD II systems) establish standards for monitoring emission systems in-use and detecting malfunctions of the monitored systems. These requirements place restrictions on the number of preconditioning cycles used by the system to determine compensation values before emission testing. The number of DFCO situations during preconditioning may not allow generation of the entire map of correction values before emission testing is performed.

The method for learning fuel adjustment values disclosed herein allows fuel quantity adjustment values to be directly determined for an initially limited number of fuel pressure values and calculates projected fuel quantity adjustment values at other pressure values different from the pressure values at which the adjustment values were directly determined. The projected fuel quantity adjustment values are then used to control fuel injection until enough DFCO occurrences have taken place to allow direct determination of fuel quantity adjustment at fuel pressure values in addition to the initially limited number of fuel pressure values.

In the description that follows, the terms WPA (worst performing acceptable) and BPU (best performing unacceptable) are used. As used herein, WPA characteristics refer to an injector having a fuel quantity drift, positive or negative, that is equivalent to 150,000 miles of usage (FUL—full useful life), without exceeding OBD II emission limits as defined by OBD II regulation. As used herein, BPU characteristics refer to an injector that has a fuel quantity drift, positive or negative, that results in emissions exceeding the OBD II emission limit. The emission limit is defined by OBD II regulation as 1.5 times the base emission standard.

In an exemplary diagnostic small quantity adjustment (diagnostic SQA) procedure, the fuel pressure in the fuel rail 170 is controlled to a predetermined value. During a DFCO condition, one fuel injector 160 is energized for a time targeted to inject a target amount of fuel into one cylinder of the engine. The angular acceleration of the crankshaft 145 produced by the combustion of the injected quantity of fuel is compared to the angular acceleration that would be produced by the combustion of a nominal fuel quantity. The diagnostic SQA procedure is able to calculate the difference in fuel quantities in terms of a value of change in energizing time (delta Energizing Time) for the given injector 160.

The exemplary SQA diagnostic procedure may include a suspicious SQA (SSQA) phase in which the given injector 160 is classified as suspicious or not suspicious. During this SSQA phase several injections are performed on the given injector 160 during several DFCO conditions in order to calculate the drift in delta energizing time of the injector over the several injections. The change in energizing time between two consecutive injections is used to assign a confidence level to the given injector. An injector is considered suspicious if the confidence level is lower than a calibratable threshold. The SSQA phase can only report a passing diagnostic result for non-suspicious injectors.

Injectors that fail the SSQA test may be tested in a validation SQA (VSQA) phase in order to validate if the injector 160 has a fault condition. The VSQA phase performs additional injections on the suspicious injector during additional DFCO conditions, generally higher than the number of injections performed during SSQA, in order to determine a more accurate drift value for the tested injector 160. If the delta energizing time calculated during the VSQA phase is higher than a calibratable threshold a diagnostic trouble code (DTC) is set. Two separate DTCs for each cylinder are associated with the VSQA diagnostic: one for excessive negative drift on fuel injection quantity and one for excessive positive drift on fuel injection quantity.

The diagnostic SQA procedure described above is performed for each of the injectors 160 in a multi-cylinder engine, with a single value of fuel rail pressure used for the characterization of all of the injectors. The diagnostic SSQAA/SQA procedure is performed at the beginning of each vehicle drive cycle, i.e. once per trip, but may be carried over to the next drive cycle if the SSQAA/SQA procedure has not performed the test on all cylinders before the end of a drive cycle.

As each value of delta energizing time is learned for each injector 160, the learned values are stored in memory to be used as a correction to a nominal energizing time for subsequent injections. In an exemplary embodiment, the learned correction value is added to the nominal energizing time to form a sum, and the injector is energized for the time represented by the sum to inject a desired amount of fuel into the cylinder.

It is desirable to characterize each of the injectors in a multiple cylinder engine at a plurality of fuel rail pressures. The time required for the SQA logic to learn compensation values for all cylinders at all test pressures may be undesirably long. To improve the emissions and diagnostic performance of the vehicle, the presently disclosed method and apparatus extrapolates the correction values learned for each injector 160 in the diagnostic SQA procedure to values at other fuel pressures. These extrapolated values can then be used to compensate for actual injector characteristics at other test pressures until the vehicle has been operated for sufficient time in the drive cycle to directly learn compensation values at the other fuel pressures.

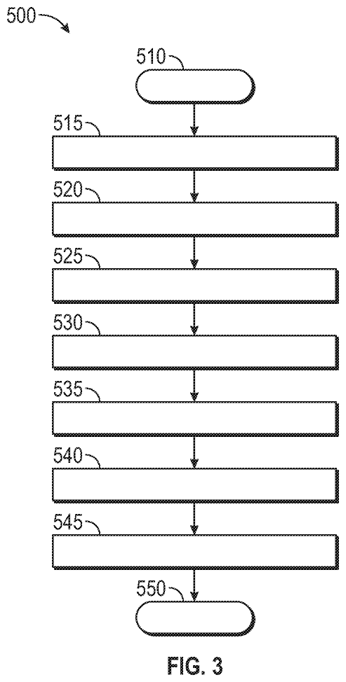

Referring to FIG. 3, a flowchart of a method 500 of learning fuel quantity adjustment values as described in the foregoing discussion in presented. The method 500 is entered at step 510 during a DFCO event. The method proceeds to step 515, where the fuel pressure in the fuel rail 170 is set to a predetermined value. In step 520, the method selects a particular injector 160 to characterize, out of the plurality of injectors in a multiple cylinder engine. The method then proceeds to step 525, where the selected injector 160 is energized for a predetermined energizing time.

Following energization of the injector, the method proceeds to step 530, where the fuel quantity that was injected is measured. This determination is made based on a measurable signal (e.g. crankshaft acceleration) that can be correlated to injected fuel quantity. In step 535, an energizing time correction value is determined corresponding to a difference between the measured fuel quantity injected and the nominal fuel quantity that would be expected based on the nominal characteristic curve at the energizing time used in step 525.

With continued reference to FIG. 3, in step 540 the energizing time correction value that was determined in step 535 for the selected injector at the selected fuel rail pressure is stored in a table. In step 545 extrapolated values of energizing time correction value for the selected injector 160 at other rail pressures are calculated based on the energizing time correction value that was determined in step 535 at the rail pressure that was set in step 515. These extrapolated values are stored in table cells corresponding to the selected injectors at the other pressures. The method 500 then ends at step 550.

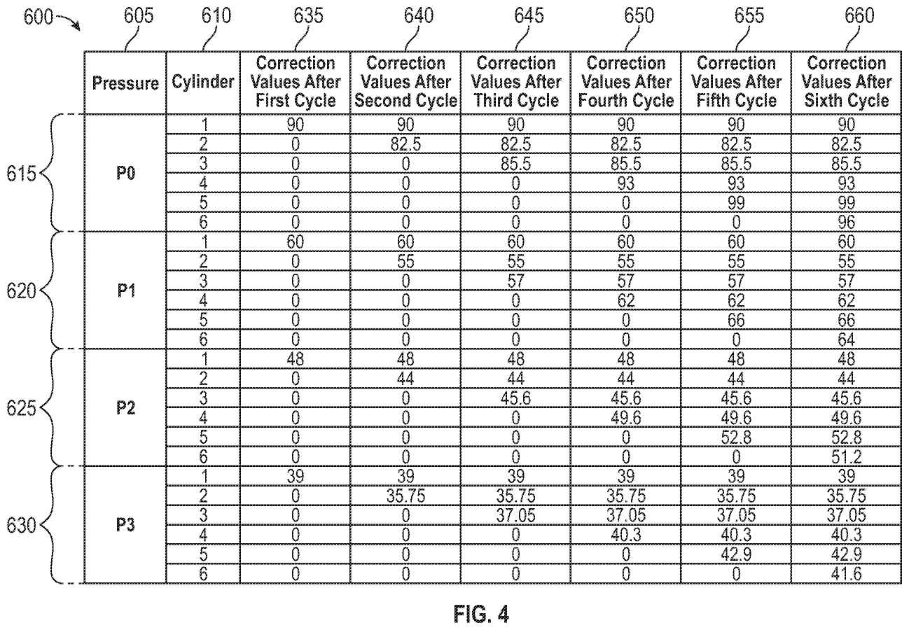

Referring to FIG. 4, a table providing examples of learned injector energizing time adjustment values according to an exemplary embodiment is presented. The non-limiting example presented in FIG. 4 assumes that there are six fuel injectors 160, i.e. a six-cylinder engine with one fuel injector per cylinder. The non-limiting example presented in FIG. 4 also assumes that energizing time correction values are determined for each injector 160 at four different fuel rail pressures. In practice, if the engine is operated at a fuel rail pressure that is different from the four rail pressures that define the table, interpolation or extrapolation can be used to determine a correction value for the actual fuel rail pressure based on the values in the table of FIG. 4. It will be appreciated that the teachings of the present disclosure can be applied in cases of more than or less than six fuel injectors, and in cases of more than or less than four different fuel rail pressures, without departing from the scope of the present disclosure.

It is desirable to learn one energizing time correction value for each injector-pressure combination. The number of energizing time correction values to be learned is the product of the injector count and the pressure count. The case depicted in FIG. 4 having six injectors and four fuel rail pressures requires twenty-four distinct correction values to be determined. The method described herein allows initial determination of all twenty-four correction values within six cycles of the method 500 depicted in the flowchart of FIG. 3, thereby enabling improved engine operation sooner than would be allowed if it were necessary to execute the method 500 of FIG. 3 twenty-four times to fully populate the energizing time correction table.

With reference to FIG. 4, a correction table 600 having twenty-four rows is depicted. Column 605 contains labels for each of four distinct rail pressure levels, labeled P0, P1, P2, and P3. Column 601 contains labels for the six distinct fuel injectors, repeated such that each of the twenty-four rows represents one of the twenty-four distinct pressure-injector combinations. The top six rows in the table, represented as range 615, represent cells in the table for each of the six injectors at the first rail pressure level P0. The second group of six rows in the table, represented as range 620, represent cells in the table for each of the six injectors at the second rail pressure level P1. The third group of six rows in the table, represented as range 625, represent cells in the table for each of the six injectors at the third rail pressure level P2. The fourth group of six rows in the table, represented as range 630, represent cells in the table for each of the six injectors at the fourth rail pressure level P3.

With continued reference to FIG. 4, each of the columns 635, 640, 645, 650, 655, and 660 represent the contents of the twenty-four learned energizing time adjustment values at a different point in time. Initially, before the method 500 depicted in FIG. 3 has been executed such as at the beginning of a drive cycle, no injector energizing time adjustment values have been learned and each cell in the correction value table is set to zero. For purpose of illustration, it is assumed that the first time the method 500 depicted in FIG. 3 is executed the fuel rail pressure is set to P1 in step 515 and the injector to characterize is selected in step 520 as the injector delivering fuel to cylinder 1. For purpose of illustration, it is assumed that the energizing time correction value is determined in step 535 to be 60 microseconds. In step 540, the determined correction value of 60 microseconds is stored in the cell corresponding to cylinder 1 at pressure P1.

In step 545 extrapolated values of energizing time correction value for the selected injector at other rail pressures are calculated based on the energizing time correction value that was determined in step 535 at the rail pressure that was set in step 515. For purpose of illustration, it is assumed that the correction value for injector at pressure P0 is obtained by multiplying the correction value determined for that injector at pressure P1 by a factor of 1.5. The resulting extrapolated correction value for injector 1 at pressure P0 is 90 microseconds (1.5 times 60 microseconds). The value of 90 microseconds is then stored in the cell corresponding to injector 1 at pressure P0.

For purpose of illustration, it is assumed that the correction value for injector at pressure P2 is obtained by multiplying the correction value determined for that injector at pressure P1 by a factor of 0.8. The resulting extrapolated correction value for injector 1 at pressure P2 is 48 microseconds (0.8 times 60 microseconds). The value of 48 microseconds is then stored in the cell corresponding to injector 1 at pressure P2.

For purpose of illustration, it is assumed that the correction value for injector at pressure P3 is obtained by multiplying the correction value determined for that injector at pressure P1 by a factor of 0.65. The resulting extrapolated correction value for injector 1 at pressure P0 is 39 microseconds (0.65 times 60 microseconds). The value of 39 microseconds is then stored in the cell corresponding to injector 1 at pressure P3.

Referring to FIG. 4, column 635 shows the contents of the correction value array after the first execution of the method 500 of FIG. 3. As shown in column 635, after one cycle of method 500 four of the correction values have been determined, i.e. the values for injector 1 at each of the four pressures. The remaining twenty-one correction values have not yet been determined at the time represented by column 635.

With continued reference to FIGS. 3 and 4, in the exemplary depiction the second time the method 500 of FIG. 3 is executed the correction value for injector delivering fuel to cylinder 2 at rail pressure P1 is determined in step 535 to be 55 microseconds. In step 540, the determined correction value of 55 microseconds is stored in the cell corresponding to cylinder 2 at pressure P1. In step 545, the correction values for cylinder 2 at P0, P2, and P3 are determined by multiplying the P1 value of 55 microseconds by 1.5, 0.8, and 0.65 respectively, yielding correction values of 82.5, 44, and 35.75 microseconds respectively. Referring to FIG. 4, column 640 represents the contents of the correction value array after the second execution of the method 500 of FIG. 3. The array now contains eight correction values: the previously determined correction values for injector 1 and the newly determined correction values for injector 2 at all four pressures. Sixteen of the correction values are still undetermined at the time represented by column 640.

With continued reference to FIGS. 3 and 4, in the exemplary depiction the third time the method 500 of FIG. 3 is executed the correction value for injector delivering fuel to cylinder 3 at rail pressure P1 is determined in step 535 to be 57 microseconds. In step 540, the determined correction value of 57 microseconds is stored in the cell corresponding to cylinder 3 at pressure P1. In step 545, the correction values for cylinder 3 at P0, P2, and P3 are determined by multiplying the P1 value of 57 microseconds by 1.5, 0.8, and 0.65 respectively, yielding correction values of 85.5, 45.6, and 37.05 microseconds respectively. Referring to FIG. 4, column 645 represents the contents of the correction value array after the third execution of the method 500 of FIG. 3. The array now contains twelve correction values: the previously determined correction values for injectors 1 and 2 and the newly determined correction values for injector 3 at all four pressures. Twelve of the correction values are still undetermined at the time represented by column 645.

With continued reference to FIGS. 3 and 4, in the exemplary depiction the fourth time the method 500 of FIG. 3 is executed the correction value for injector delivering fuel to cylinder 4 at rail pressure P1 is determined in step 535 to be 62 microseconds. In step 540, the determined correction value of 62 microseconds is stored in the cell corresponding to cylinder 4 at pressure P1. In step 545, the correction values for cylinder 4 at P0, P2, and P3 are determined by multiplying the P1 value of 62 microseconds by 1.5, 0.8, and 0.65 respectively, yielding correction values of 93, 49.6, and 40.3 microseconds respectively. Referring to FIG. 4, column 650 represents the contents of the correction value array after the fourth execution of the method 500 of FIG. 3. The array now contains sixteen correction values: the previously determined correction values for injectors 1, 2, and 3, and the newly determined correction values for injector 4 at all four pressures. Eight of the correction values are still undetermined at the time represented by column 650.

With continued reference to FIGS. 3 and 4, in the exemplary depiction the fifth time the method 500 of FIG. 3 is executed the correction value for injector delivering fuel to cylinder 5 at rail pressure P1 is determined in step 535 to be 66 microseconds. In step 540, the determined correction value of 66 microseconds is stored in the cell corresponding to cylinder 5 at pressure P1. In step 545, the correction values for cylinder 5 at P0, P2, and P3 are determined by multiplying the P1 value of 66 microseconds by 1.5, 0.8, and 0.65 respectively, yielding correction values of 99, 52.8, and 42.9 microseconds respectively. Referring to FIG. 4, column 655 represents the contents of the correction value array after the fifth execution of the method 500 of FIG. 3. The array now contains twenty correction values: the previously determined correction values for injectors 1, 2, 3, and 4, and the newly determined correction values for injector 5 at all four pressures. Sixteen of the correction values are still undetermined at the time represented by column 655.

With continued reference to FIGS. 3 and 4, in the exemplary depiction the sixth time the method 500 of FIG. 3 is executed the correction value for injector delivering fuel to cylinder 6 at rail pressure P1 is determined in step 535 to be 64 microseconds. In step 540, the determined correction value of 64 microseconds is stored in the cell corresponding to cylinder 6 at pressure P1. In step 545, the correction values for cylinder 6 at P0, P2, and P3 are determined by multiplying the P1 value of 64 microseconds by 1.5, 0.8, and 0.65 respectively, yielding correction values of 96, 51.2, and 41.6 microseconds respectively. Referring to FIG. 4, column 660 represents the contents of the correction value array after the sixth execution of the method 500 of FIG. 3. The array now contains twenty-four correction values: the previously determined correction values for injectors 1, 2, 3, 4, and 5 and the newly determined correction values for injector 6 at all four pressures. None of the correction values are still undetermined at the time represented by column 660.

In the example depicted in FIG. 4 it is assumed that correction values for each cylinder at rail pressures P0, P2, and P3 are determined by multiplying the correction value for that cylinder at rail pressure P1 by 1.5, 0.8, and 0.65 respectively. It will be appreciated that the actual correction values may be different from those used in the example depending on the actual rail pressure values P0, P1, P2, P3. It will also be appreciated that the extrapolation of a correction value to a different rail pressure is not limited to a simple multiplication by a predetermined constant. Extrapolation involving adding a predetermined offset value, a combination of a predetermined multiplier and a predetermined offset, and other mathematical functions may be applied to a measured value to obtain an extrapolated value without departing from the scope of the present disclosure. It will also be appreciated that the present disclosure is not limited to a total of four rail pressure values, but may be extended to any number of rail pressure values.

The method disclosed herein allows an array of correction values to be determined by a combination of direct measurement and extrapolation in less time than would be required to fully populate the array with directly measured values. In an aspect of the disclosure, once the array of correction values is fully populated by a combination of direct measurement and extrapolation, the method 500 is executed (with the omission of extrapolation step 545) with a rail pressure value and injector selection for which only an extrapolated value is available. The correction value thus determined is saved in the correction value array, replacing the value previously obtained by extrapolation. This continues until the array is fully populated with directly determined correction factors or until the vehicle is shut off, whichever occurs first.

A method of the present disclosure offers several advantages. These include rapid learning of injector energization time correction factors in less time than direct learning would take. As a result, emissions performance and diagnostic ability are enhanced earlier in a vehicle operating cycle.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of operating a fuel injector of an internal combustion engine, comprising the steps of:
determining an actual energizing time correction value for a fuel injector at a first fuel rail pressure;
calculating a first extrapolated energizing time correction value by performing a first mathematical calculation on the actual energizing time correction value; and
controlling the operation of the fuel injector based on the actual energizing time correction value and the first extrapolated energizing time correction value.

2. The method of claim 1, wherein the step of determining an actual energizing time correction value comprises the steps of:
setting the fuel rail pressure of a fuel rail to the first fuel rail pressure, the fuel rail being configured to provide fuel to the fuel injector;
performing a test injection by energizing the fuel injector for a first energizing time at the first fuel rail pressure;
determining an actual quantity of fuel injected by the fuel injector during the test injection; and
determining an actual energizing time correction value as the difference between the first energizing time and a nominal energizing time corresponding to the actual quantity of fuel injected during the test injection.

3. The method of claim 1, wherein the engine is a multi-cylinder engine comprising one fuel injector per cylinder, and wherein the steps of determining an actual energizing time correction value and calculating a first extrapolated energizing time correction value are performed once for each of the plurality of fuel injectors in the engine.

4. The method of claim 1, further comprising the step of calculating a second extrapolated energizing time correction value by performing a second mathematical calculation on the actual energizing time correction value.

5. The method of claim 4, further comprising the step of calculating a third extrapolated energizing time correction value by performing a third mathematical calculation on the actual energizing time correction value.

6. The method of claim 1, wherein the first mathematical calculation comprises multiplying the actual energizing time correction value by a predetermined constant.

7. The method of claim 1, wherein the first mathematical calculation comprises adding the actual energizing time correction value to a predetermined constant.

8. The method of claim 1, wherein the first mathematical calculation comprises multiplying the actual energizing time correction value by a first predetermined constant and adding the product of the multiplication to a second predetermined constant.

9. The method of claim 1, wherein the step of determining an actual energizing time correction value is performed during a DFCO event.

10. An automotive system comprising an electronic control unit configured to carry out the method according to claim 1.

11. A non-transitory computer-readable medium containing instructions that, when executed on a computer, performs the method according to claim 1.

12. An apparatus for operating a fuel injector of an internal combustion engine apparatus comprising an electronic control unit configured to:
determine an actual energizing time correction value for a fuel injector at a first fuel rail pressure;
calculate a first extrapolated energizing time correction value by performing a first mathematical calculation on the actual energizing time correction value; and
control the operation of the fuel injector based on the actual energizing time correction value and the first extrapolated energizing time correction value.

13. The apparatus according to claim 12 further comprising a non-transitory computer-readable medium associated with the electronic control unit and including a computer program having programming instructions.

14. A method of operating a fuel injector of an internal combustion engine, comprising the steps of:
determining an actual energizing time correction value for a fuel injector at a first fuel rail pressure;
calculating a first extrapolated energizing time correction value by performing a first mathematical calculation on the actual energizing time correction value; and
controlling the operation of the fuel injector based on the actual energizing time correction value and the first extrapolated energizing time correction value;
wherein the step of determining an actual energizing time correction value comprises the steps of:
setting the fuel rail pressure of a fuel rail to the first fuel rail pressure, the fuel rail being configured to provide fuel to the fuel injector;
performing a test injection by energizing the fuel injector for a first energizing time at the first fuel rail pressure;
determining an actual quantity of fuel injected by the fuel injector during the test injection; and
determining an actual energizing time correction value as the difference between the first energizing time and a nominal energizing time corresponding to the actual quantity of fuel injected during the test injection.

15. The method of claim 14, wherein the engine is a multi-cylinder engine comprising one fuel injector per cylinder, and wherein the steps of determining an actual energizing time correction value and calculating a first extrapolated energizing time correction value are performed once for each of the plurality of fuel injectors in the engine.

16. The method of claim 14, further comprising the step of calculating a second extrapolated energizing time correction value by performing a second mathematical calculation on the actual energizing time correction value.

17. The method of claim 16, further comprising the step of calculating a third extrapolated energizing time correction value by performing a third mathematical calculation on the actual energizing time correction value.
